(19) United States
(12) Patent Application Publication
(10) Pub. No.: US 2024/0144122 A1
(43) Pub. Date: May 2, 2024

(54) SYSTEM AND METHOD FOR SCHEDULING AND MANAGING EMPLOYEE BREAKS

(71) Applicant: ONECLICKAPP, LLC, Lindon, UT (US)

(72) Inventors: James Frank Finlinson, Lindon, UT (US); Jan Frank Finlinson, Lindon, UT (US); Eric Longberg, Murray, UT (US)

(73) Assignee: ONECLICKAPP, LLC, Lindon, UT (US)

(21) Appl. No.: 18/384,343

(22) Filed: Oct. 26, 2023

Related U.S. Application Data
(60) Provisional application No. 63/420,032, filed on Oct. 27, 2022.

(51) Int. Cl. G06Q 10/0631

(52) U.S. Cl. CPC G06Q 10/063116

(57) ABSTRACT

A break management system automatically calculates employee break schedules for a large number of employees according to both legal requirements as well as business operating needs. Businesses may enter preference rules regarding the timing of breaks relative to other breaks and relative to other employees and work positions. The break management system provides a user interface with required breaks, suggested break windows, and break timing requirements for each employee and allows a shift leader to manage breaks from the interface.

### PRIORITY

The present application claims the benefit of U.S. Provisional Application Ser. No. 63/420,032, filed Oct. 27, 2022, which is herein incorporated by reference in its entirety.

### THE FIELD OF THE INVENTION

The present invention relates to employee breaks. In particular, examples of the present invention relate to a system to schedule and automate employee breaks in a manner that improves efficiency in the workplace.

### INTRODUCTION

Efficient management of employee breaks (rest periods) is problematic for many businesses. Restaurants, for example, have several employees working together and at the same time. The demands of this type of business require that employee stations are staffed at all times, and that breaks are managed to provide employees with either legally-required, awarded or requested breaks.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a schematic drawing which shows a flow diagram of a break management system.

FIG. 2 is a drawing which shows a chart of configurable break rules.

FIG. 3 is a drawing which shows a chart of configurable break rules.

FIG. 4 is a drawing which shows a chart of configurable break rules.

FIG. 5 is a schematic drawing which shows functionality of the break window module.

FIG. 6 is a drawing of a break management system user interface.

FIG. 7A is a drawing of a break management system user interface screen.

FIG. 7B is a drawing of a break management system user interface screen.

FIG. 8 is a drawing of a break management system user interface screen.

FIG. 9 is a drawing which shows a break data report.

FIG. 10 is a drawing which shows an employee break report.

FIG. 11 is a drawing which shows a computer system for implementing the break management system.

FIG. 12 is a schematic drawing which shows components of a break management computer.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Embodiments may also be implemented in cloud computing environments. In the description and claims, “cloud computing” may be defined as a system for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud system can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

As used herein, “adjacent” refers to near or close sufficient to achieve a desired effect. Although direct contact is common, adjacent can broadly allow for spaced apart features.

As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be “one or two above” or “one or two below” the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

The disclosure particularly describes a system to manage employee breaks. Particularly, the present disclosure describes how a computer system may be used to automatically create a break schedule and provide this to a shift manager in a way that the scheduling of and implementing employee breaks is mostly automated.

Many businesses, like restaurants, employ young and/or relatively inexperienced workers and have high turnover rates. Managing employees is more difficult in businesses with high turnover rates and sometimes young, inexperienced, and short-term employees. These businesses often have employees that do not work in a single and consistent position at all times. Restaurant employees may rotate between different positions on different days and even during different time periods during a shift. For similar reasons, these businesses often also have relatively inexperienced managers or employee leaders. Even with some experience, it can be challenging for businesses to find leaders capable of managing a working shift with a large number of employees because of the number of variables that are required for proper and efficient management. Most managers also manage a number of different employees in different roles and with varying skills and qualifications. Managers also operate within federal and state laws and business operating parameters for the employees being managed. For employee breaks, the manager may manage different break lengths based on time worked, age, or waiver status.

There are a complex set of rules that dictate when employees should take breaks and how long those breaks should be. Different states have different break rules and the application of each state's rules require a consideration of a variety of factors, including the time of day, the age of the employee, the shift(s) involved, the total number of hours in a shift, the start and stop times of the shifts, etc. States have a wide variety of procedures for enforcing the break rules. Some states have whistleblower statutes that allow employees or other individuals to submit complaints regarding employee break violations and business may face fines or lawsuits for break violations.

For a company with many employees, locations in multiple states, with a wide range of shifts, employee ages, and changing operating hours, complying with the break rules can be challenging. Further not complying with break laws constitutes a significant financial and legal risk for the companies. State laws regarding breaks often include break restrictions such as:

Rest Breaks: Employees must be allowed a paid rest period, free from duties, of at least 10 minutes for every 4 hours worked.

Employees cannot be required to work more than 3 hours without a rest break.

Breaks must be scheduled as close to the midpoint of a work period as possible.

Employers can require workers to stay on the job site during a rest break.

Rest breaks taken are considered “hours worked” when calculating paid sick leave and overtime.

Meal Periods: Employees must be allowed a meal period when they work more than five hours in a shift. A meal period must be at least 30 minutes long and start between the second and fifth hour of the shift.

It is laborious for businesses to track and manage breaks. Shift leaders have to decide which order and when each employee should go on break to comply with the break rules. Further the shift leaders have to make the breaks happen without disrupting the operation of the business. They then should document the breaks the employees have taken to ensure that the employees have complied with the law. The shift leaders may also be required to find a “breaker” who fills in/covers for the people who are breaking. All this can be overwhelming to young shift leaders who have many more tasks to perform in addition to managing breaks for their employees.

In addition to state laws, many businesses have operating requirements that need to be met with regards to employee break scheduling in order to keep the business operating at an acceptable level of efficiency. A restaurant, for example, will need to schedule breaks to minimize the impact of employee breaks on business operations. Breaks may need to be scheduled around busy periods for the business. Breaks may need to be coordinated with other employee breaks to ensure that a minimum staff is maintained. Employee breaks may need to be coordinated to ensure that various employee positions are filled while employees are on break. The business may have three workstations that perform the same task and may only want one of the three workers at these three stations on break at a given time. Additionally, there may be a variety of time constraints that must be met. For example, the business may have a lunch time surge in customers or a shipping deadline in the early afternoon. For best results it would be better for employees to take breaks that are not in these time periods.

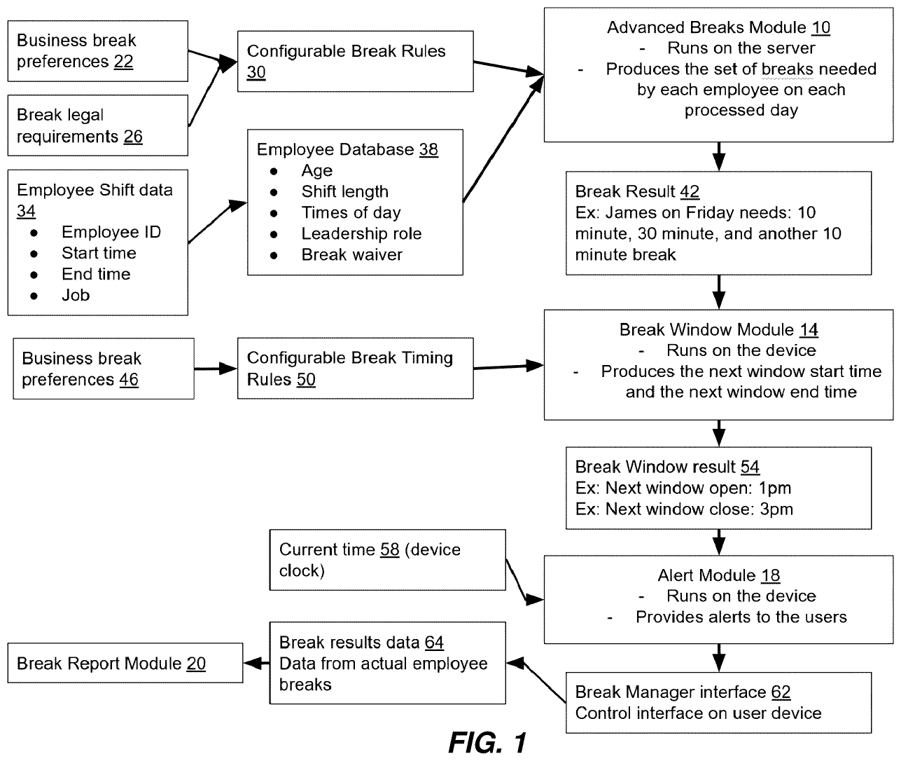

FIG. 1 illustrates a computer implemented employee break management system for scheduling and implementing an employee break schedule. The resulting break schedule ensures compliance with business preferences as well as legal requirements and facilitates proper break scheduling and reporting with minimal input from a shift leader at the business. A computer is used to receive input and create break scheduling and present a break scheduling and management interface to a business shift leader. The computer implements the break scheduling through an Advanced Breaks Module 10, a Break Window Module 14, and an Alert Module 18. Although some of the processes may be discussed as being implemented by a module for clarity in description, it is appreciated that these processes are implemented by a computer which is running customized software to thereby implement the module and the associated processes and steps. Via the Advanced Breaks Module 10, the computer creates a Break Result which includes employees working during a shift (i.e., a selected period of work time such as a work shift or working day) and which includes the necessary breaks for these employees. Via the Break Window Module 14, the computer calculates a Window Result from the Break Result which includes allowable windows during which each break can be taken during the shift. Via the Alert Module, the computer provides a Break Manager interface operating on a computer display which provides a break schedule and alerts to a shift leader and which allows a shift leader to place employees on and off of breaks and which records the breaks taken by employees.

The Advanced Breaks Module receives and stores business break preferences 22 and break legal requirements 26. The business break preferences may include business requirements such as employee stations that need to be manned, busy times when breaks should not occur, offsetting of breaks between employees working at similar or related stations, etc. Break legal requirements may include state and federal legal requirements for employee breaks and may vary state to state, for particular industries, and for differing employee ages. From the business break preferences 22 and break legal requirements 26, the computer calculates and stores configurable break rules 30. Configurable break rules combine the legal requirements for breaks with the business break preferences to create rules about when breaks are taken by employees.

The Advanced Breaks Module 10 also receives shift employee data 34 for the shift. The shift employee data 34 typically includes an employee id, start and end time for the shift, and an employee job. The computer stores an employee database 38 which stores employee id, age, shift length, times of day worked, training or leadership role, and any applicable break waiver. The Advanced Breaks Module 10 calculates a break result 42 from the employee shift data 34 and the configurable break rules 30. The break result 42 includes each break which is necessary for each employee during the shift. While a single shift is discussed, it is appreciated that the computer may be used to create a break schedule and the break manager interface for all shifts.

The Break Window Module 14 receives business break preferences 46 and calculates configurable break timing rules 50 which identify windows of time during the shift during which each break may be taken. The Break Window Module 14 processes the break result 42 according to the break timing rules 50 and creates a break window result 54. The break window result 54 includes break length and start and stop times for each break for each employee working during the shift.

The Alert Module 18 receives the current time 58 and the break window result 54 and creates the break manager interface 62. The break manager interface is displayed to the shift leader on a computer interface/display. The break manager interface displays the shift employees and break related information for each employee. The list of employees is typically displayed chronologically in order of upcoming break related events, such as a needed break. The break manager interface also allows the shift leader to start and stop breaks for the employees.

The Break Report Module 20 provides reporting information to business managers regarding how breaks are run, provides verification of breaks, and provides data necessary for management of payroll and other break related business operations.

Advanced Breaks Module:

The Advanced Breaks Module 10 is responsible for processing raw shift data and break rules to produce a single set of breaks that belong to each individual employee. Business break preferences 22 are stored by the computer and used in calculating employee breaks. Business break preferences may include employee work positions which should not be on break at the same time as other particular employee work positions, preferred time staggering of breaks, or even whether a business wants to schedule breaks beyond those required by law. Break legal requirements are state laws regarding breaks which must be provided to employees. Laws regarding breaks vary state to state. State laws requiring breaks may require a rest break for every N hours if an employee is working more than a minimum amount of time and a meal break if an employee works more than another threshold amount of time. These requirements may be different for minor workers. The computer creates configurable break rules based on break legal requirements in the state where the business operates and business break preferences. The configurable break rules are defined and stored in the computer. These break rules can be visualized as rows in a table. A rules engine is used to select the most appropriate break rule from the set based on several criteria:

The combined length of the shifts associated with an employee

The age of the employee

The time of day that the shift covers

The leadership role(s) of the employee

The existence of a signed break waiver for an employee

Some employees may be assigned multiple shifts during a day. For example, an employee may be assigned to work a certain position/task for a period of time, may then be assigned to attend a training session, and may then be assigned to work a different position/task for another period of time. The Advanced Breaks Module 10 combines consecutive shifts belonging to the same employee into a run of shifts spanning a single combined time period while calculating the combined shift run length. For each run of shifts, the Advanced Break Module 10 chooses one row of the table of shift lengths which corresponds to the time worked by the employee and identifies the breaks that the employee needs to take for that day from the corresponding row of the table.

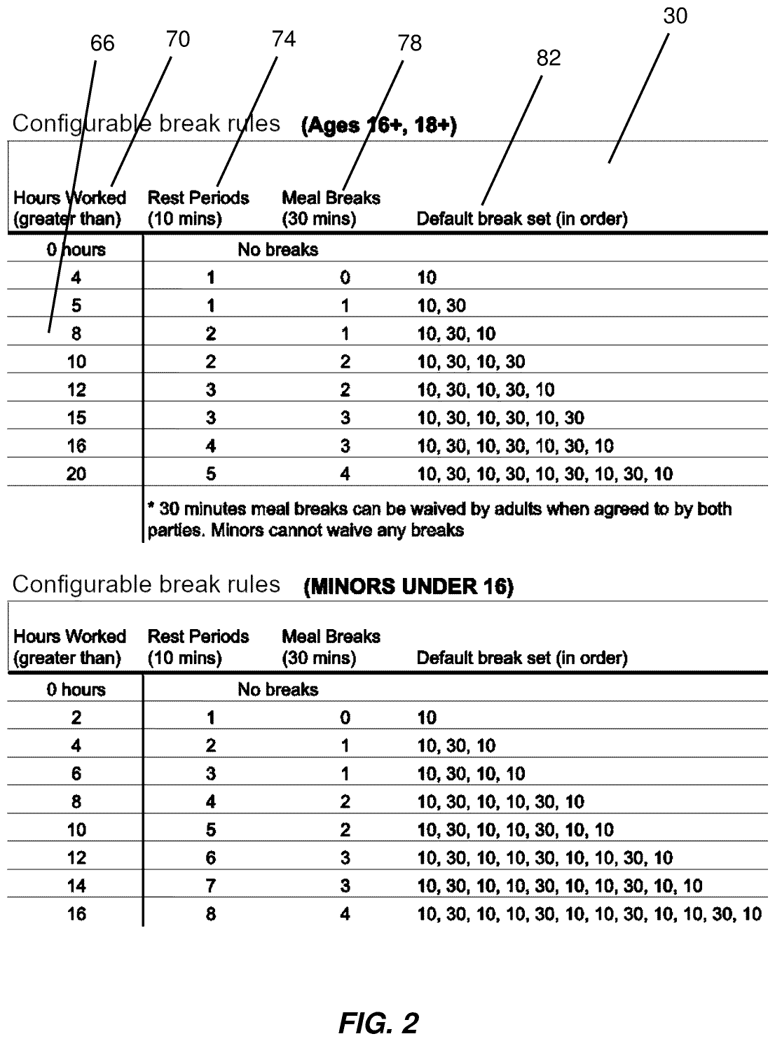

FIG. 2 shows a table of configurable break rules 30 which correspond to state break rules for a business operating in a state which requires a greater number of breaks. Separate sections or tables are shown for adult workers and minor workers because there are different break rules based on worker age. When there are different break rules for different age workers, separate tables may be used for different ages, or separate columns or sections within a table may be used to represent different ages. The computer receives employee shift data 34. The employee shift data 34 includes employee id, start time(s), end time(s), and jobs/work stations for each employee during a shift. The computer will receive employee database 38 information. Employee database information will include information such as the age, shift length, leadership role, and any break waivers for each employee. For each employee, the computer will determine a combined shift length, age, etc. The computer will identify a table/section of table based on the employee age. The computer will then identify a row 66 in the table that corresponds to the combined length of a run of shifts for that employee. If an adult employee works for 3 hours, participates in a 1 hour training, and then works for 2 hours, the employee is treated as working a 6 hour shift. The tables are typically created and stored to analyze employee shift lengths as being “greater than” specified periods of time and therefore falling within a certain table row. The computer identifies the corresponding shift time in the table first column 70. Six hours, for example, is greater than 5 hours (row 3) and is not greater than 8 hours (row 4) so row 3 applies to the employee. The computer then identifies in column 2 (74) that the employee will need 1 10 minute rest period and identifies from column 3 (78) that the employee will need 1 30 minute meal break. The computer identifies in column 4 (82) that, for this company, these breaks will be ordered to first have a 10 minute meal break and later have a 30 minute meal break. In this manner, the computer will identify all employees for a given shift or day and, via the Advanced Break Module 10, will create an ordered list of all breaks for each employee.

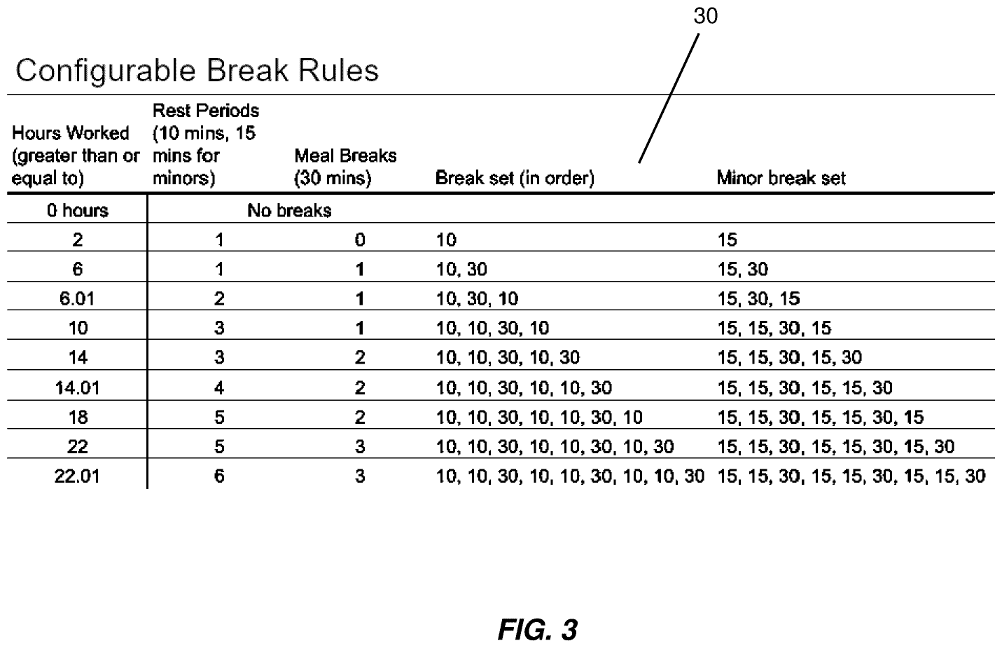

FIG. 3 shows an alternate format for a table of configurable break rules 30. Rather than having a separate table for minor employees, the configurable break rules table 30 includes break rule columns pertaining to minors (the Minor break set column) and break rule columns pertaining to adults (the Break set (in order) column). The time column is also formatted as “greater than or equal to” and shows time values for combined shift lengths accordingly.

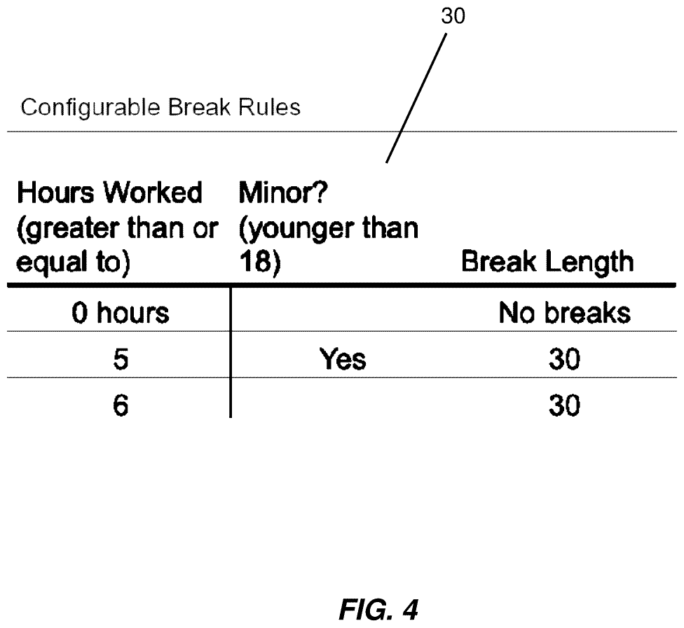

FIG. 4 shows a configurable break table for a state which requires fewer breaks. This example features a relatively simple set of rules where the minor rule is visualized as a separate row in the table. The break management system can handle diverse legal and company break requirements.

Break Window Module:

The Break Window Module 14 receives the employee break data from the Advanced Breaks Module 10 and determines the windows of time during which each break can occur. This information will be used by the alert module to present just one instruction to the shift leader, representing the next required action.

Business break preferences 46 are used to create configurable break timing rules 50 which describe windows of time in a shift that a break can be run. Configurable break timing rules can describe an individual break, or can apply to all breaks generally. Each break can have multiple associated rules defining the start and end of the break window in various terms. Zero or more global break timing rules can be defined that apply to all of the breaks in the sequence.

Break timing rules may define the start or the end of the break window and may define a break window time relative to the start or the end of the shift, or relative to other breaks taken. Break timing rules may define the break window relative to hours into a shift, or a percent of the shift as a whole. For example, a rule may state that meal breaks should occur between the second and the fifth hour of the shift, or that a rest break should occur before the fourth hour of the shift. Break timing rules may indicate that certain positions (such as cashier 1) are not to take breaks when other positions (such as cashier 2) are on break. Break timing rules may identify time periods when breaks are to be avoided such as peak busy hours when all employees need to be working. Break timing rules may also identify that breaks should not be run in the first or last hour (a predetermined time period) of a shift or that two breaks for an employee should not be run within 30 minutes (a predetermined time period) of each other. Break timing rules may indicate that a meal break should be run near a meal time and rest breaks should be distributed around other time periods of the employee shift.

The break window module 14 processes a set of breaks for a single employee at a time, which is associated with one or more shifts after they have been combined into a single combined shift. In one aspect, the Break Window Module 14 can calculate timing windows for employee breaks at the start of a day or shift and transmit the result to the Alert Module 18. In another aspect, the Break Window Module 14 can continuously or periodically calculate timing windows for employee breaks throughout the shift and transmit updated break timing windows and information to the Alert Module 18. In this manner, the Break Window Module 14 can account for missed or delayed breaks and can help ensure legal break compliance even if company policies regarding break timing are not achieved.

An employee break is in one of the following states on the user interface provided to the shift leader from the Alert Module 18:

Pending—The employee is intended to go on break next. Visualized as a break status indicator in yellow.

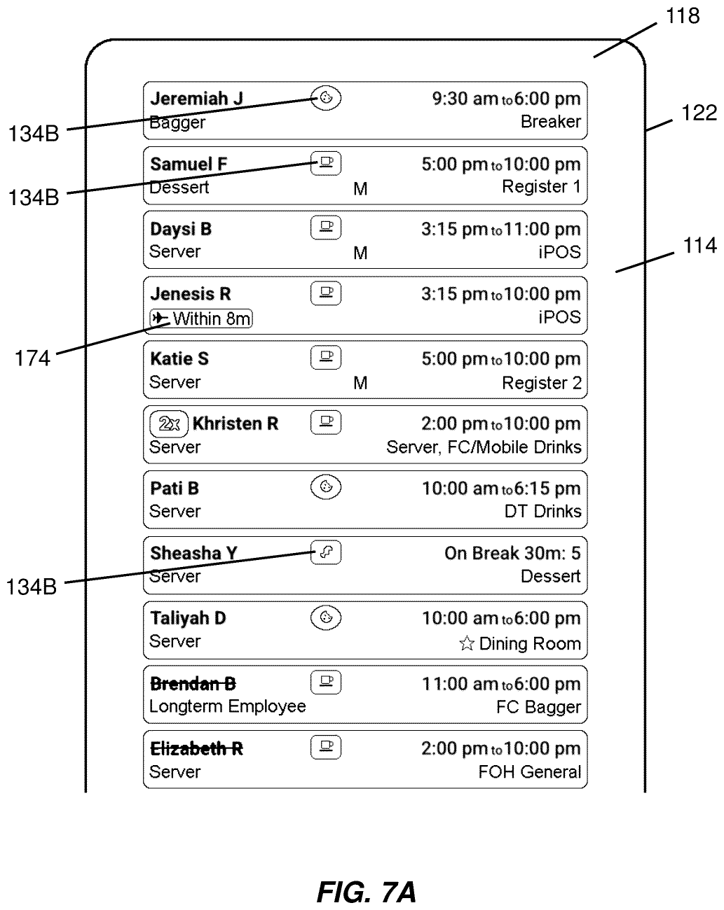

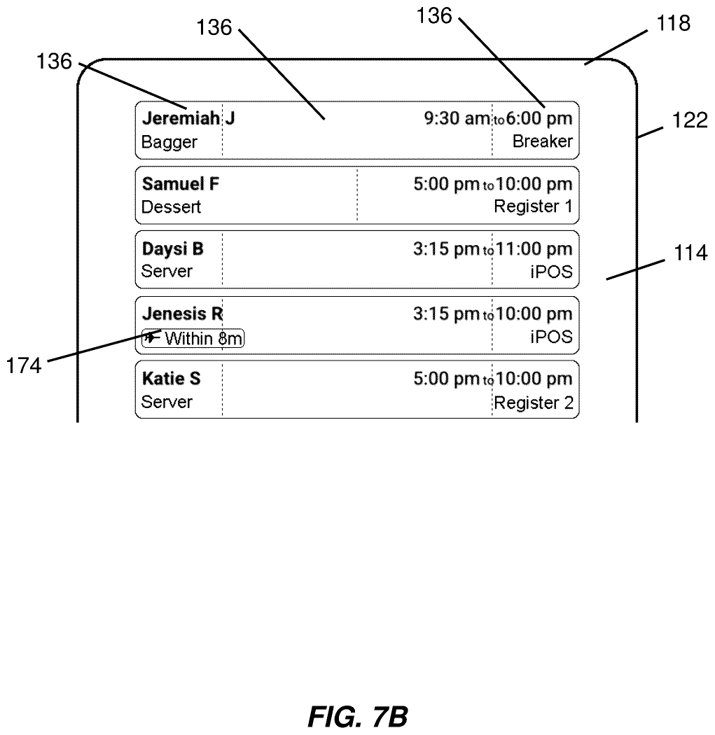

OnBreak—The break and its timer have started. Visualized in light green. The OnBreak icon is illustrated as a turkey leg icon in FIG. 7A.

NeedsBreak—There are still breaks that need to be run for an employee. Visualized in red squares which each represent a break. The NeedsBreak icon is illustrated as a coffee cup icon in FIG. 7A.

HadBreak—Breaks have been run for an employee. Visualized in blue circles which each represent a completed break. The HadBreak icon is illustrated as a cookie icon in FIG. 7A.

NoBreak—No breaks were needed for an employee. Visualized as empty space.

MultipleOptions—A user needs to choose between multiple sets of break options. Visualized with a single red square with a question mark icon.

The break window module 14, skips set of breaks/employees that are not in the NeedsBreak phase; indicating that the employee has had all of their breaks or does not need a break for the shift being worked. The Break Window Module 14 processes each break individually, skipping any required break that has already been run. In calculating break windows, the Break Window Module 14 will apply all applicable (specific and global) rules to the break. In one example, the Break Window Module 14, takes the latest allowed Break Window start and takes the minimum allowed Break Window end to create a break window during which the break should occur. When multiple employee breaks produce colliding break windows, one of the employee breaks is shifted forward in time and additional padding time is added between the break windows.

From these results, the Alert Module 18 displays the next instruction for this employee to the shift leader as:

Next break window start time: the earliest allowed break start time

Next break window end time: The earliest allowed break end time

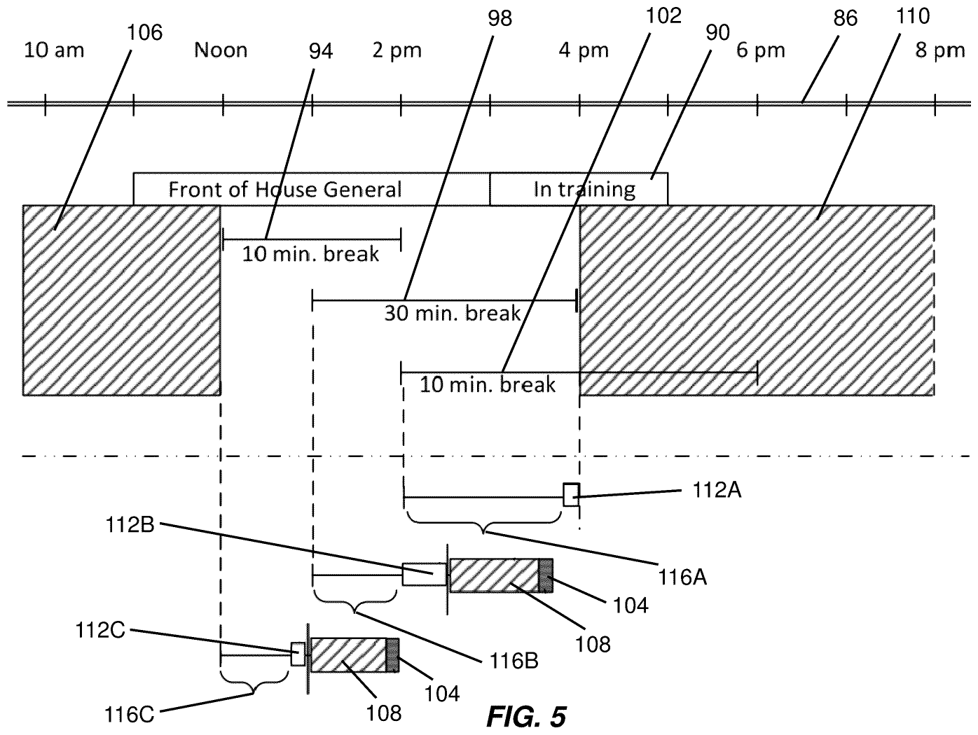

FIG. 5 is a diagram showing one illustrative example of how the break window module calculates break windows for an employee. A time line 86 runs from left to right across the top, with the first time being 9 am and the last time being 8 pm. The employee (James) has two shifts: “front of house general” from 11 am to 3 pm and “training” from 3 pm to 5 pm. Consequently, his combined shifts are from 11 am to 5 pm as indicated at 90. The advanced breaks module calculates this raw shift data to produce a single set of breaks throughout that are associated with the employee (James).

The advanced breaks module 10 has determined that the combined shift length for James is 6 hours, that he is an adult and that the store location is in California. Consequently, the advanced breaks window identifies from Configurable Break Rules that James should take three breaks: 10 minute break, a 30 minute break and then a 10 minute break. The advanced breaks module transmits this information to the break window module 14 which then calculates a raw break window for each break by applying state laws (e.g., the laws for California) as reflected in the configurable break rules. In this case, the three raw break windows are: a first window 94 for a 10 minute break that extends from noon to 2 pm; a second window 98 for a 30 minute break from 1 pm to 4 pm and a third window 102 for a 10 minute break from 2 pm to 7 pm. The raw break windows define the start times for the breaks without regard to any particular spacing of the breaks. For example, if only the raw breaks were considered, James could take his breaks at any time during the windows. He could take a 10 minute break at 1 pm, a 30 minute break at 1:10 pm and another 10 minute break at 2 pm. This bunching of breaks or other available timing may be undesirable for the business. Consequently, business defined configurable break timing rules 50 based on business preferences 46 may be applied to the break windows. For example, a rule may be created that says that the breaks should never be run within 15 minutes of each other (break spacing indicated at 104) and that 60 minutes time should be placed between each break (“planning padding” or break padding indicated at 108). A global timing rule (company break preference rule) may be created that says that breaks should not be run within 60 minutes of starting a shift (indicated at 106) or that breaks should not be run within 60 minutes of ending a shift (indicated at 110). These company break rules are customizable for each business/location.

The Break Window Module applies these additional rules and begins calculating breaks (112A, 10 minute break, 112B, 30 minutes break, 112C 10 minute break) based on the latest time the last break could be taken and calculating forward to the other breaks. The end result is an allowable break window 116A, 116B, 116C for each break. In this case, the calculated break window 116A for James's last 10 minute break 112A is from 2 pm to 3:50 pm. This allowable break window 116A represents the time window in which James's last 10 minute break could be started.

The break window module then calculates the allowable break window 116B for James's 30 minute break 112B by accounting for (e.g. adding) 15 minutes of spacing and 60 minutes of padding (for a total of 75 minutes) to a break length to thereby calculate that the 30 minute break window should start 105 minutes before the break should end at 1 pm and end at 2:05 pm. The next allowable break window 116C for James's first 10 minute break 112C is calculated in a similar way by accounting for 15 minutes of spacing and 60 minutes of padding to determine that the first 10 minute break window starts at noon and ends at 12:40 pm.

The allowable break windows 116A, 116B, 116C indicate the windows during which the breaks 112A, 112B, 112C can begin and still be compliant with the laws governing the breaks and the configurable break rules established by the company. Each allowable break window 116A, 116B, 116C defines the earliest and latest times a break 112A, 112B, 112C can be started and still be compliant with state and company rules. The allowable break window thus defines the worst case compliant option of when breaks can be started and remain compliant. The system allows for customization of global timing values, spacing times, padding times, and when breaks can start and end relative to the start and end of shifts for each business or each location within a business.

The illustration and description shown above is only one example of a break window module. A variety of alternatives could be used in accordance with the principles described. For example, various steps or operations could be combined, reordered, replaced, or eliminated. In one alternative embodiment, the padding and spacing operations could be replaced by a single time period and/or the calculation of break windows could proceed from the earliest time to the latest time the break could be taken. Additionally, instead of using raw break windows the module may directly calculate the final break windows. Additional parameters may be used to calculate break windows, including but not limited to: availability of replacements for the work station, break times for other employees on the shift, busy times of day, travel time to an off-site responsibility, or other parameters.

Alert Module:

The Alert Module 18 creates a user interface which represents the state of the breaks and any important timing windows to the shift leaders and which allows shift leaders to start and stop breaks and manage employee behavior with respect to breaks. The Alert Module 18 receives the break window results 54 from the Break Window Module 14 and receives current time input 58; typically from a computer system clock. The Alert module compares a few pieces of information to compute the alert state and create the user interface:

The current state of each employee's breaks

The current time of day

The next break window start time for each employee

The next break window end time for each employee

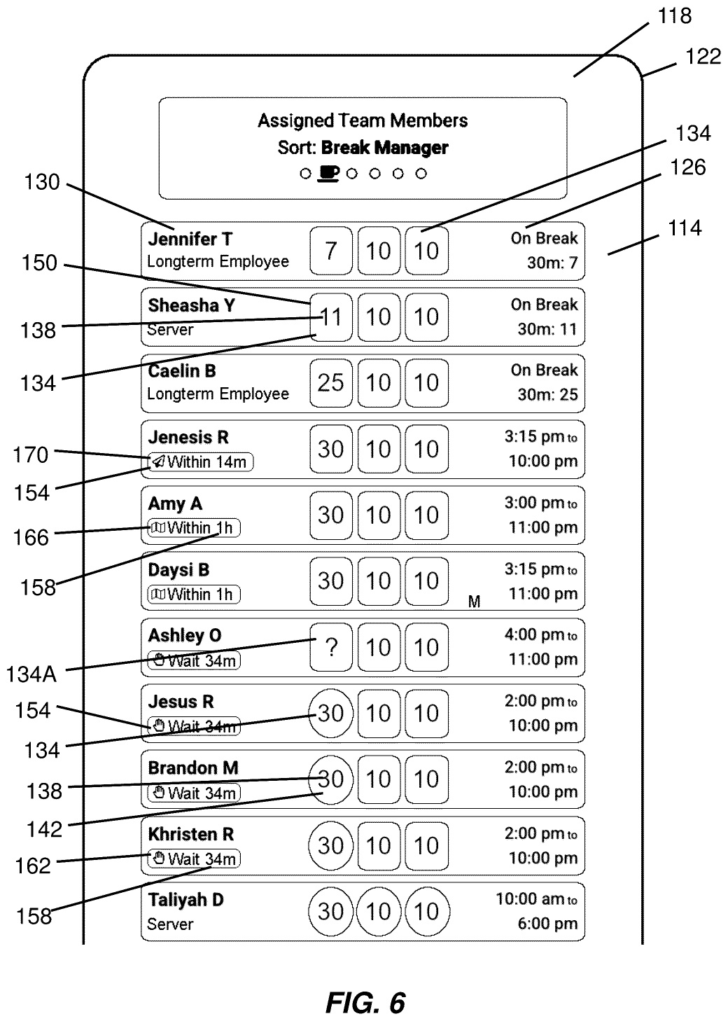

FIG. 6 shows a drawing of the Break Manager user interface 114 which is created by the Alert Module and presented to the shift leader via a computer display 118 such as a touch screen on a smart phone or table computer 122. The user interface 114 includes a number of display boxes or cards 126. Each card 126 is associated with an employee and the user interface shows a card for each employee who is working during the shift. The card 126 includes the employee name 130 in addition to several status indicators, notifications, and interface elements for the employee. Employee phases or indicators are displayed as colored badges associated with the employees in each employee card 126. Different colors combined with different indicators provide the employee break status and break interface. Each employee card includes one or more break status indicators 134. In the example user interface 114, the break status indicators 134 are located to the right of the employee name 130. Each break status indicator 134 represents a break which should occur during the employee's shift. As shown, the status indicators 134 are the same shape and colors for rest breaks and for meal breaks although these could be represented with different shapes and colors as needed. The break status indicators 134 each include a number 138 which represents the length of the break in minutes associated with the particular status indicator 134. In the example user interface 114, there are a mixture of 10 minute rest breaks and 30 minute meal breaks for the employees. Break status indicators 134 may include the following states:

NeedsBreak—There are still breaks that need to be run. Employee break status indicators 134 which represent a break that still needs to occur are displayed as red squares (indicated at 142) which include a number 138 indicating the length (and thus the type) of break. All squares with a 10 or a 30 inside are red and indicate that a 10 or 30 minute break is needed for the employee.

PendingBreak—There are still breaks that need to be run. A NeedsBreak indicator can be interacted with (clicked, etc.) to turn the break status indicator into a yellow PendingBreak status indicator. The yellow PendingBreak break status indicator indicates the employee who is intended to go on break next, and can be clicked on again to change it into a green OnBreak break status indicator. Alternatively, the system may automatically change a NeedsBreak break status indicator into a PendingBreak break status indicator and allow a shift leader to interact with the indicator to send an employee on break and change the indicator into green OnBreak break status indicator. Alternatively, the shift leader may interact with a NeedsBreak indicator and put it into the PendingBreak indicator by instructing the employee to go on break and automatically change the break status indicator to an OnBreak break status indicator based on the employee time clock system when the employee clock out and actually starts the break.

HadBreak—All the breaks have been run. Employee break status indicators 134 which represent a break that has already occurred are displayed as blue circles (indicated at 146) which include a number indicating the length of the completed employee break.

OnBreak—The break and its timer have started. Employee break status indicators 134 which represent a break which has begun and is currently in process are displayed as light green squares (indicated at 150) which include a number 138 indicating the remaining length of the break in minutes. In the drawing, the left squares in the first three rows are green (and have the numbers 7, 11, and 25) indicating that the employee is on break.

NoBreak—No breaks were needed. If an employee shift is short enough that no breaks are needed, no break status indicators 134 are presented in the employee card and the location for the break status indicators is displayed as empty space.

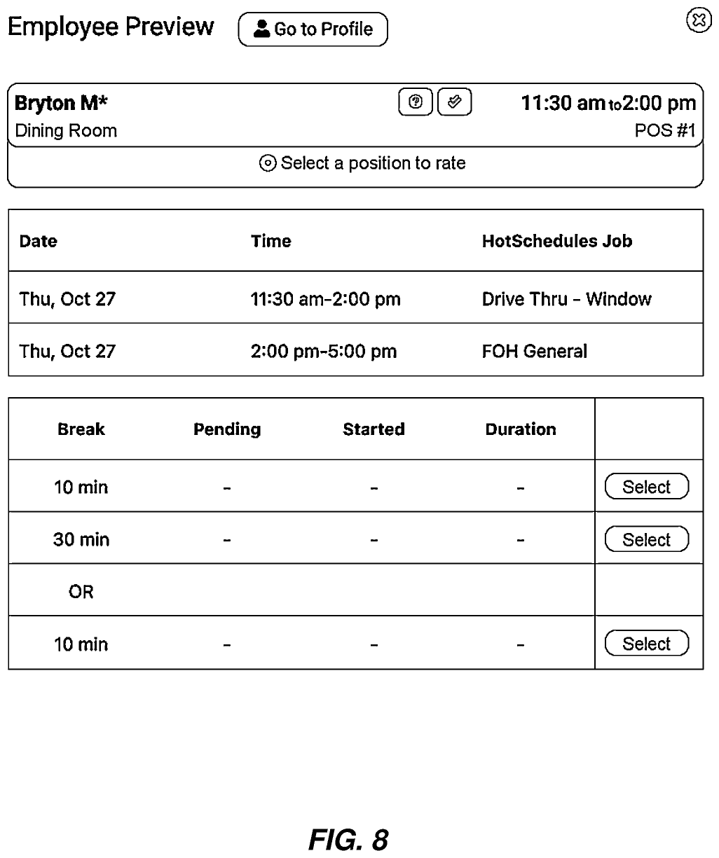

MultipleOptions—A shift leader needs to choose between multiple sets of break options for this employee. In some situations, an employee may have signed a break waiver making a break not required. In this situation, the user interface may present a pop up window or user interface element to the shift leader indicating that they need to indicate if a particular break would be taken or skipped. Alternatively, a company may indicate in its break preferences that an employee may take a single 30 minute break or two 10 minute breaks and the shift leader would enter this selection to allow the break management system to select the desired number and length of breaks. In some situations, employee breaks may be optional. For example, employees may be able to waive a longer (unpaid) meal break and continue working when a signed waiver is in place with the company. In this situation, the employee break status indicator 134A is displayed with a single red square with a question mark icon instead of a number representing a break length. The question mark icon indicates to the shift leader that a decision needs to be made about the break. If the shift leader selects the question mark icon in break status indicator 134A, the system would take them to the user interface screen shown in FIG. 8 and allow the shift leader to make a decision about whether or not the employee will take an upcoming break and start/stop/manage the break by interacting with the user interface, such as by touching the (Select) icon on the break section of the user interface as shown on the bottom of FIG. 8. FIG. 8 shows an example user interface screen where a shift leader must select from multiple break options for an employee. The example shows where an employee has a break waiver and a shift manager must select between a 10 minute rest break or both a 10 minute rest break and a 30 minute meal break.

In this manner, the employee cards 126 and break status indicators 134 quickly show a shift leader the state of employee breaks to facilitate management of the employee breaks.

Each employee card 126 in the user interface also includes a break timing alert 154. The break timing alert 154 can be in one of several states based on the above input factors. Each state is associated with its own color and icon to help shift leaders distinguish between the states. The break timing alert may also include a number 158 which indicates the time remaining for this alert. The break timing alert 154 can be in one of the following states:

Wait: The next start window is in the future. An employee break timing alert 154 for employees with breaks that are in the future and which have not yet entered the computer selected start time for the break window are displayed in grey (indicated at 162). This indicates to the shift leader that the employee should not be sent on break right now. The “wait” break timing alert is displayed with an open palm hand gesture to indicate that the shift leader should take no action now for this employee. The “wait” break timing alert displays the time 158 remaining until the break window opens.

Within ‘X’ hour/minute: Signals that the break window is open for X more hours or minutes. An employee break timing alert 154 that says “within” indicates that the employee is currently inside of a break window. This break timing alert changes color and changes the displayed icon as the time draws close to the close of the break window and starting the employee break becomes more urgent. The “within” break timing alerts are displayed in green, yellow, and then orange depending on the closeness to the end of the break window and the urgency in starting the break. The “within” break timing alerts are displayed with varying icons that indicate urgency. For example, the green break timing alert 154 is typically displayed when greater than 20 or 30 minutes remains in the break window and is associated with a trail map or a walking icon as is indicated at 166. The yellow break timing alert 154 is typically displayed when less than 15 or 20 minutes remain for an employee to go on break and is displayed with a paper airplane icon as indicated at 170. The orange break timing alert 154 is typically displayed when less than 10 minutes remain in the break window for an employee to go on break and is displayed with a jet icon as indicated at 174 in FIG. 7A.

Break now: Signals the last chance to start the break and be compliant with the configured timing rules. A “break now” break timing alert is typically displayed in deep orange.

Past “X” hour/minutes: Signals that the shift leader ran out of time to send an employee on break and be compliant a certain amount of time ago (indicated by the displayed time). The shift leader should run the break immediately to minimize the extent of the non-compliant break behavior. The “past” break timing alert 154 is displayed in red.

No break timing alert: For employees where the next break windows are far in the future or far in the past, no break timing alert is shown. Other information such as the employee position or workstation can be displayed instead.

The appropriate timing alert may be calculated as follows:

If the shift is not in the NeedsBreak nor MultipleOptions state, no alert is shown.

If the next break window start time is after the current time, display WAIT and calculate and display the time as the difference between the next break window start and the current time.

If the next break window close is before the current time, display PAST and Calculate and display the time value as the difference between the current time and the next break window end.

Otherwise (if the current time is after the next break window start time and before the next break window end time), display WITHIN and calculate and display the appropriate color based on the difference between the window close and the current time, calculate the time value as the difference between the next window close and the current time.

For all break timing alerts 154, format and display the result as the break timing alert 154 in the associated employee card 126 and display the time difference in either minutes or hours, whichever is more appropriate for the value.

The Break Manager interface 114 includes user interface elements which allow a shift leader to directly manage employee breaks. For example, the break status indicators 134 may be user interface elements which can be touched on a touch screen display or clicked/interfaced with a mouse or other computer user interface device to start and stop breaks, time the employee breaks, and record data about the employee breaks including whether a break was taken by the employee, when the break was taken, and how long the break was.

The break timing alerts display in full detail while viewing the Break Manager screen as shown in FIG. 6. The most critical portions of the Break Manager view are displayed in other user interface screen views as shown in FIG. 7A. Outside of the Break Manager interface view 114, all of the prompts are suppressed except for PAST, and WITHIN prompts in the orange or deep orange states. This allows shift leaders to focus on other critical information while still having the break alert system as a safety net to provide urgent break information. FIG. 7A illustrates an alternate (simplified) user interface view of the system which allows a shift leader to view information and perform tasks such as employee position assignment, training status, shift time, etc. The user interface shows a reduced number of break status indicators 134B that indicate breaks for various employees. The break status indicators 134B may be displayed as a Blue Cookie to indicate that all breaks are done for an employee for their shift. The break status indicators 134B may be displayed as a Green Turkey Leg to indicate that the employee is on break. The break status indicators 134B may be displayed as a Red Coffee Cup (or as a Red Question Mark for an employee with multiple break options as discussed above) when there is still a future break that needs to occur during a shift. A still simplified Break Manager user interface as shown in FIG. 7B may simply display a screen with each of the employees names in individual icon boxes. The icon boxes may show a background color to indicate the break status. Thus, the icon boxes may show different colors such as a blue background for employees where all breaks for a shift are done, a green background for employees that are on break, and a red background for employees that still have a break that needs to occur during a shift. The icon box backgrounds may be segmented into a number of different areas positioned horizontally sequentially across the box according to a number of breaks during a shift for the associated employee. If an employee has three breaks, the icon background may be segmented into three areas and each are may include a background color as described above according to the status of that break. Further, the icon box background may be segmented into a number of different areas 136 according to the number of different breaks for an employee associated with the icon box and the areas may be smaller or larger according to the length of the break. For example, the icon box background may be segmented according to length of break where, for an employee with 10, 30, and 10 minute breaks during a shift, the icon box background may be segmented into areas that are the left 20 percent, the middle 60 percent, and the right 20 percent of the background to indicate the shorter and longer breaks. The shift manager may interact with the icon boxes to start and stop breaks.

The Break Manager user interface 114 prioritizes all of the employees on the shift based on the result of the break window calculations to provide direction on who should go on break next and provide information to the shift leader about the most urgent break related tasks. Calculation is as follows:

Employees who are on break currently are displayed at the top of the list.

Employees who have a break window that closes soonest are at the top of the list.

Employees whose break window opens earlier sort higher on the list than employees whose break window opens later.

Anyone who needs no breaks or has already finished all their breaks sort at the bottom.

Within these sorting processes, ties are broken by comparing the following other details of the shifts in order until the tie is broken.

Windows open for longer sort higher.

Name—alphabetical sort.

The Break Manager user interface 114 provides a prioritized list of the employees who should go on break next, with a visualization of all the breaks that have been and need to be run on the shift, including prompts to the shift leader indicating when each break should be run next.

The break management system also includes a Break Report Module 20 (FIG. 1).

The break report module 20 provides break data the regarding how breaks were actually run in the store to shift leaders and business owners/managers. The Break Report Module 20 allows for verification of employee break compliance as well as management of business aspects such as payroll which may be affected by employee break compliance. Break results data 64 is recorded from actual employee break start and stop times as well as other break data and recorded by the break management system. The break results data 64 may be queried to provide report and compliance data. Break reports are generated by querying employee break data according to several filter options:

Employee name

Break Date

The length of the break. In states where some breaks are paid and others are unpaid, this allows managers or shift leaders to retrieve information for breaks that are most important to a particular decision.

Unused minutes—the number of minutes of break taken under the time allotted Excess minutes—the number of minutes of break taken over the time allotted

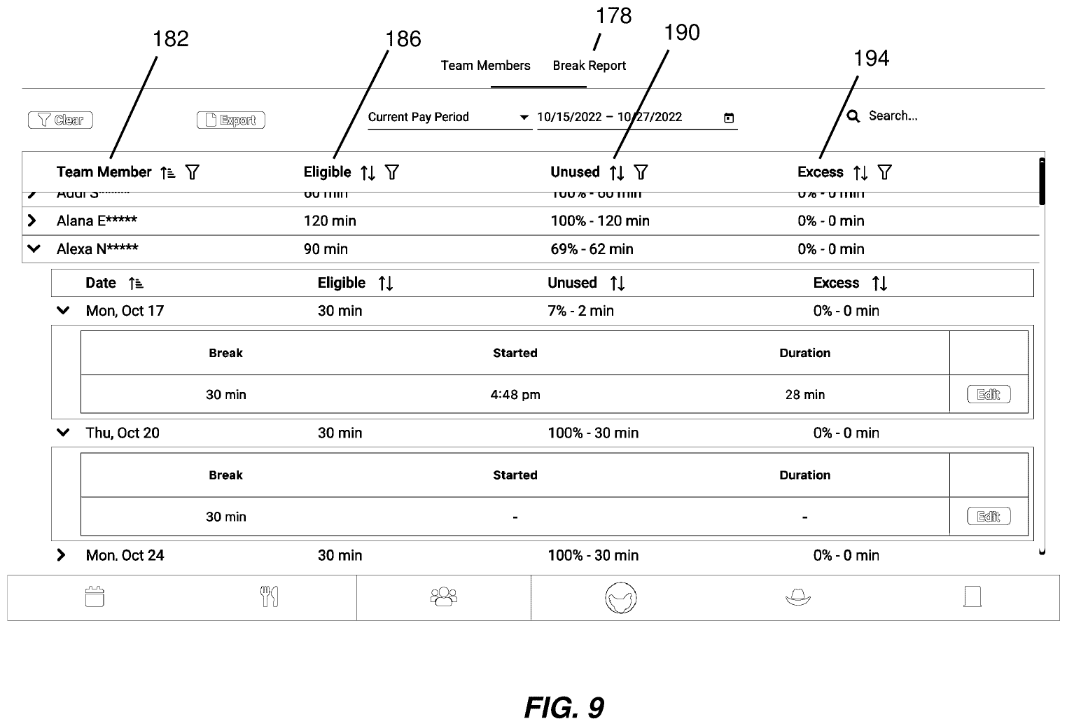

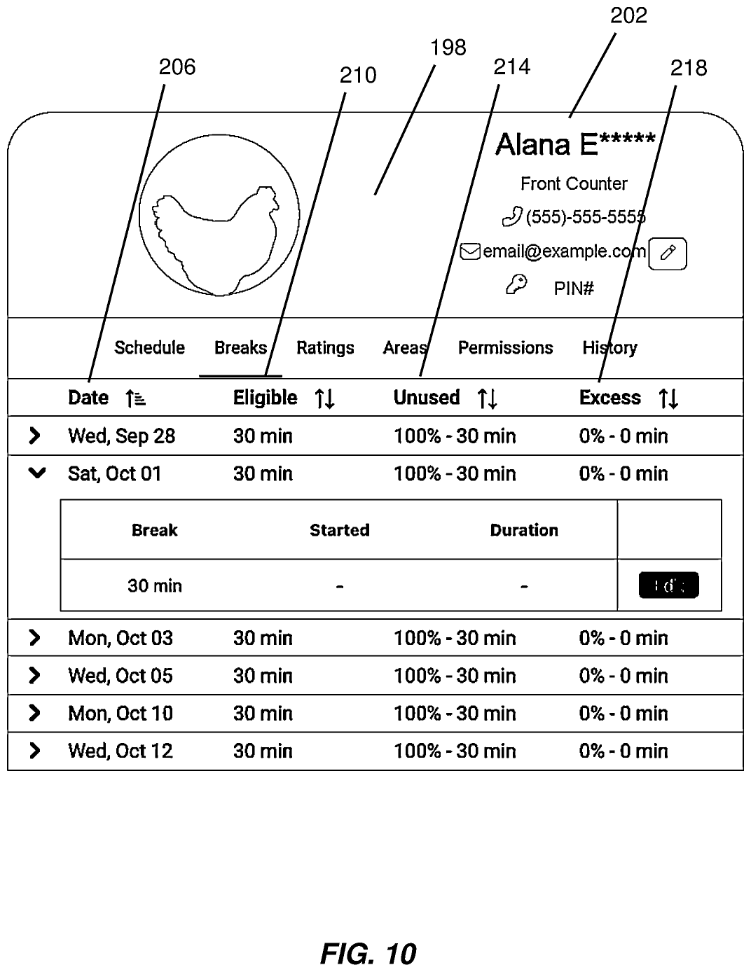

FIG. 9 shows a break report 178 which includes columns for employee name 182, eligible break minutes 186, unused break minutes 190, and excess break minutes 194. FIG. 10 shows a detailed break report 198 which is limited to an individual employee. The individual break report 198 includes additional employee information 202, columns for dates 206, eligible break minutes 210, unused break minutes 214, and excess break minutes 218. Individual dates can be selected to view additional information for breaks on that day including as when breaks started and stopped.

These reports help managers identify employees who are not acting in compliance with the rules the store has created. It provides a foundation of data from which managers can begin investigating the cause of non-compliance, whether it be leaders who fail to follow the schedule as outlined by the break manager system, or employees who fail to go on break and return in a timely manner. Commonly, this helps leaders find employees staying on break long after their paid breaks (stealing time from the store) and by catching breaks that were not correctly logged in the time-clock system. The break management system allows businesses to easily and near automatically manage breaks for a large number of employees. The system is easily customized to allow break schedules to accommodate business needs in addition to meeting legal requirements. The system allows breaks to be easily managed from a simple user interface and only requires that a shift leader view the suggestion of upcoming breaks and start and stop breaks for employees according to suggested schedules. The break management system automatically logs data from the breaks and allows for easy verification of compliance with break policies. The break management system allows a relatively unskilled shift leader to appropriately manage breaks for a large number of employees in compliance with business needs.

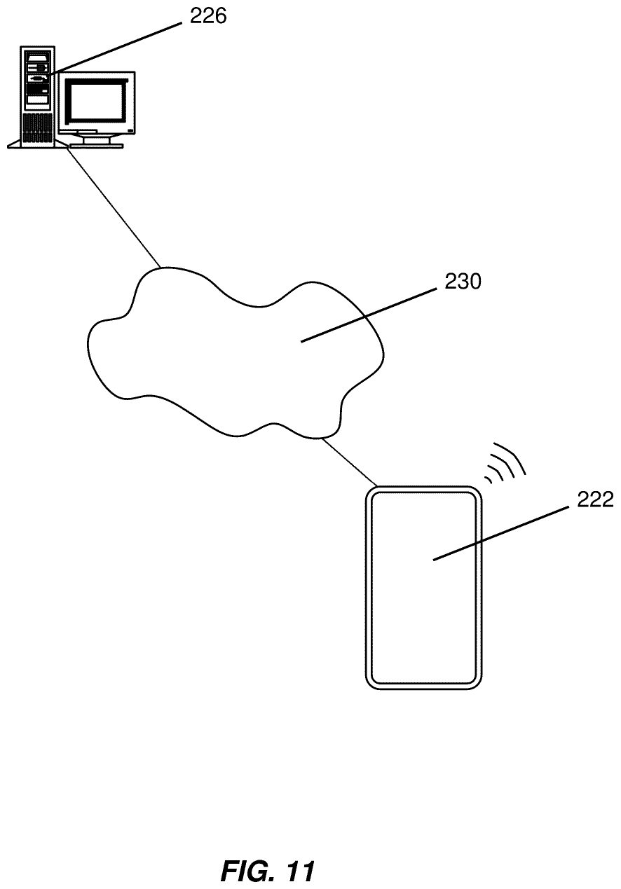

FIG. 11 illustrates an example computer system which may implement the break manager system described herein. In one example, the break manager system may be implemented on a single computer 222 which may be a desktop or laptop computer or which may be a portable computer such as a table or smart phone. In this example, the computer 222 stores the software and data necessary to implement the break management system and performs the calculations and processes discussed herein. In another example, the break manager system may be implemented on multiple computers such as a server 226 or computer which performs many of the calculations associated with the break management system and which transmits and receives information from a separate computer 222 which facilitates user input and presents break manager system information to the user via the user interface. In this example, secondary computer 226 stores much of the software and data necessary to implement the break management system and performs much of the calculations and processed discussed herein. The secondary computer 226 communicates with a computer 222 which presents the break manager user interface to a shift leader. The computer 222 is typically operated by the shift leader and may communicate with a separate computer or server 226 via a wired or wireless network 230 including via the internet as is necessary. The computer 222 may be a tablet computer or a smart phone. All break management system tasks may be performed by a single computer 222 or some system tasks may be performed by a second computer 226 and system tasks may be distributed accordingly.

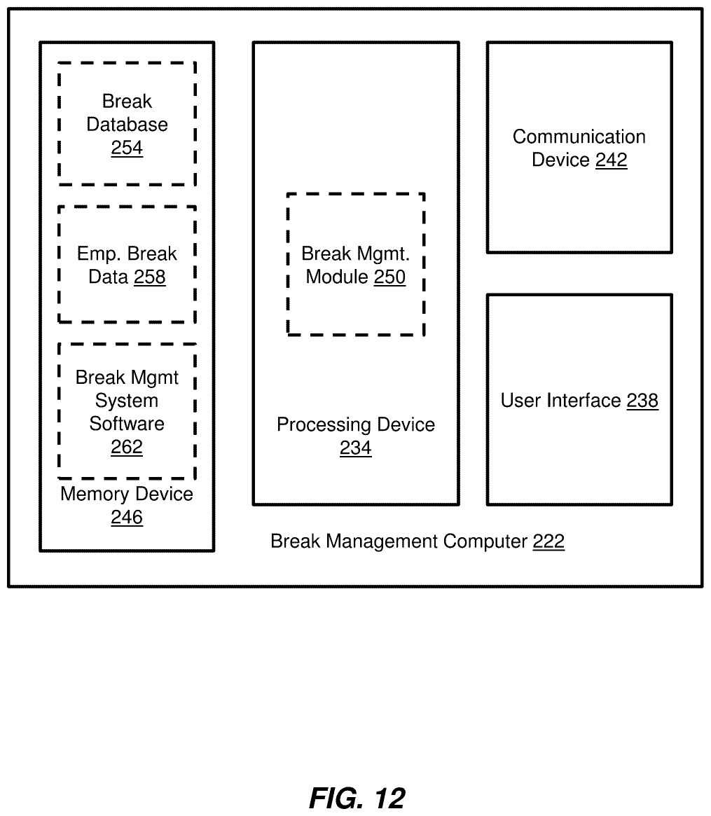

Referring now to FIG. 12, a schematic illustrating example components of the computer 222 is shown. In one example, the computer 222 includes a processing device 234, a user interface 238, a communication device 242, and a memory device 246. It is noted that the computer 222 can include other components and some of the components are not required in every example.

The processing device 234 can include memory, e.g., read only memory (ROM) and random access memory (RAM), storing processor-executable instructions and one or more processors that execute the processor-executable instructions. In embodiments where the processing device 234 includes two or more processors, the processors can operate in a parallel or distributed manner. The processing device 234 can execute the operating system of the computer 222. In the illustrative example, the processing device 234 may also execute a software module 250 such as a break management module 250.

The break management module 250 allows the computer 222 to communicate with a shift leader and to complete various processing and storage tasks associated with the break management module system described herein. The break management module 250 may allow the computer 222 to receive business preferences, shift information, and employee information described herein to thereby calculate break schedules and windows and present the break manager user interface 114 to the shift leader, receive break task commands from the shift leader, and record break data. The break management module 250 may perform the various tasks discussed herein.

The user interface 238 is a device that allows a user such as the shift leader to interact with the computer 222. While one user interface 238 is shown, the term “user interface” can include, but is not limited to, a touch screen, a physical keyboard, a mouse, a microphone, and/or a speaker. The computer user interface 238 presents the break manager user interface 114 to the shift leader and allows the shift leader to start and stop breaks, perform other functions related to employee breaks, etc. The communication device 242 is a device that allows the computer 222 to communicate with another device; such as computer 226 if necessary. The communication device 242 can include one or more wireless transceivers for performing wireless communication and/or one or more communication ports for performing wired communication.

The memory device 246 is a device that stores customized software programming to thereby implement the break management system described herein. The memory device 246 also stores data generated or received by the computer 222 by the break management system and may provide data to the processing device 234. The memory device 246 can include, but is not limited to, a hard disc drive, an optical disc drive, and/or a flash memory drive. The memory device 246 may include a break database 254 which stores data regarding business break preferences, break legal requirements, configurable break rules, configurable break timing rules, employees, shifts, and other data necessary to implement the break management system described herein. The processing device 234 may be used to create the break database 254 from business data and from calculations performed by the break management system. The memory device 246 may also include employee break data 258 including when breaks are taken, the length of breaks, and other recorded data which may be used by the Break Report Module 20 to provide compliance and analytical data. The memory device may also store break management system software 262. The memory device may also have other tables or modules as are necessary to implement the various tasks and examples discussed herein.

Where the break management system operates largely on a remote computer 226, the computer 226 will have the features discussed herein with respect to computer 222 and FIG. 11. Computer 222 will typically still have many of the features shown in FIG. 11 and the computer 226 will transmit data to computer 222 as necessary to allow the computer 222 to operate the break management system.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, times, etc., are provided for explanation purposes and that other values may also be employed in other examples in accordance with the teachings of the present invention.

What is claimed is:

1. A computer implemented method for scheduling and managing employee breaks comprising:
a computer having a processor and memory receiving business break preference rules and legal requirements for breaks;
the computer creating configurable break rules from the business break preference rules and the legal requirements;
the computer receiving employee shift data;
wherein the employee shift data includes shift start times and end times;
the computer calculating break result data comprising a required number of breaks and length of breaks for a work shift for each employee based on the employee shift data and the legal requirements;
the computer calculating break windows for each employee break according to business preference rules; wherein each break window provides a start time and a stop time for a window of time which is longer than an associated break time and wherein the associated break should begin during the break window; and
the computer displaying, to a user, a user interface which displays the break windows.

2. The method of claim 1, wherein the user interface displays, to the user, break timing alerts which show time remaining before a break window opens and which show time remaining before a break window closes.

3. The method of claim 1, wherein the user interface displays, to the user, break status indicator icons, and wherein the break status indicators display break times in minutes for breaks.

4. The method of claim 3, wherein the break status indicator icons display time remaining for in progress breaks.

5. The method of claim 3, wherein the break status indicator icons are displayed in different combinations of shape and color for completed, uncompleted, and in progress breaks.

6. The method of claim 5, wherein the break status indicator icons display uncompleted breaks in red, display completed breaks in blue, and display in progress breaks in green.

7. The method of claim 1, wherein the user interface presents an ordered list of employees with employees on break highest, followed by employees within break windows with upcoming breaks ranked based on proximity of upcoming break window closing events, followed by employees outside of break windows ranked based on proximity of upcoming break window opening events.

8. The method of claim 3, wherein the break status indicator is a user interface button and an uncompleted break indicator can be interacted with by a user to start a break and then later interacted with by a user to stop a break.

9. The method of claim 1, wherein the user interface displays a break timing alert for each employee with an upcoming break, and wherein the break timing alert displays an indication to send an employee on break within a designated time period for employees that are currently inside of a break window, and wherein the break timing alert displays an indication to wait for a designated time period for employees that are currently outside of a break window.

10. The method of claim 1, wherein the user interface presents a prioritized list of employees wherein employees that should go on break first based on break window closing times and opening times are listed first.

11. A computer implemented method for scheduling and managing employee breaks for a business comprising:
a computer having a processor and memory receiving employee shift data, the employee shift data including shift start times and shift end times;
the computer receiving legal requirements for breaks based on a location of the business;
the computer determining a number and length of breaks for each employee based on employee shift data and break legal requirements;
the computer receiving business break preference rules, the business break preference rules comprising at least one of: a rule regarding timing of breaks for an employee relative to other breaks for that employee, a rule regarding timing of breaks for an employee relative to shift start time for that employee, and a rule regarding timing of breaks for an employee relative to shift end time for that employee;
the computer calculating break windows for each employee break according to business break preference rules; wherein each break window provides a start time and a stop time for a window of time which is associated with a required employee break, and wherein the associated break should begin during the break window; and
the computer displaying, to a user, a user interface which displays the calculated break windows for each employee.

12. The method of claim 11, wherein the user interface displays, to the user, break timing alerts, wherein the break timing alerts display at least one of time remaining before a break window opens and time remaining before a break window closes.

13. The method of claim 11, wherein the user interface displays, to the user, break status indicator icons, and wherein the break status indicators display break times in minutes for upcoming breaks.

14. The method of claim 13, wherein the break status indicator icons display time remaining for in progress breaks.

15. The method of claim 13, wherein the break status indicator icons are displayed in different combinations of shape and color for completed, uncompleted, and in progress breaks.

16. The method of claim 11, wherein the user interface presents an ordered list of employees with employees on break highest, followed by employees within break windows with upcoming breaks ranked based on proximity of upcoming break window closing events, followed by employees outside of break windows ranked based on proximity of upcoming break window opening events.

17. The method of claim 13, wherein the break status indicator is a user interface button and an uncompleted break indicator can be interacted with by a user to start a break and then later interacted with by a user to stop a break.

18. The method of claim 11, wherein the user interface displays a break timing alert for each employee with an upcoming break, and wherein the break timing alert displays an indication to send an employee on break within a designated time period for employees that are currently inside of a break window, and wherein the break timing alert displays an indication to wait for a designated time period for employees that are currently outside of a break window.

19. The method of claim 11, wherein the user interface presents a prioritized list of employees wherein employees that should go on break first based on break window closing times and opening times are listed first.

20. The method of claim 11, wherein the method comprises the computer displaying in the user interface, for each employee, a break timing alert comprising at least one of:
a no alert when breaks are far in the future or far in the past;
a wait alert when the next break window is in the future, wherein the wait alert displays a countdown timer indicating the time before a break can be started;
a within alert when the break window is open for a limited amount of time, and wherein the within alert displays a countdown timer indicating the time limit when a break should be started;
a break now alert indicating the last chance to start a break and be compliant with the business break preference rules and break legal requirements; and
a past time alert indicates that the break has not been taken within the break window and should be taken immediately.
